(19) United States
(12) Patent Application Publication
(10) Pub. No.: US 2014/0290447 A1
(43) Pub. Date: Oct. 2, 2014

(54) PLIERS

(71) Applicant: KNIPEX-Werk C. Gustav Putsch KGO, Wuppertal (DE)

(72) Inventors: Uwe Schwierzke, Velbert-Neviges (DE); Martin Pech, Wuppertal (DE); Norbert Preusser, Wuppertal (DE)

(73) Assignee: KNIPEX-Werk C. Gustav Putsch KG, Wuppertal (DE)

(21) Appl. No.: 14/355,670

(22) PCT Filed: Oct. 24, 2012
(86) PCT No.: PCT/EP2012/071038

§ 371 Date: May 1, 2014

(30) Foreign Application Priority Data
Nov. 2, 2011 (DE) 10 2011 054 986.2

(51) Int. Cl. B25B 7/02

(52) U.S. Cl. CPC B25B 7/02
USPC 81/385

(57) ABSTRACT

The invention relates to pliers (1), comprising two plier legs (2, 3) and a jaw opening (M) formed by jaws (7, 8), wherein retaining elements (9) that can be rotated relative to a jaw (7, 8) are arranged in the jaw opening (M) in order to grasp ends of a spring clamp (11) and the plier legs (2, 3) are connected to each other in an intersection region (4). According to the invention, in order to provide pliers for installing or removing spring clamps that are ergonomically designed as favorably as possible with regard to hand forces to be applied, the plier legs (2, 3) can be adjusted relative to each other in steps in the intersection region (4) in order to change the size of the jaw opening (M).

The invention relates to a pair of pliers, comprising two pliers legs and a pliers mouth formed by mouth jaws, wherein in the pliers mouth are arranged retaining elements, which are rotatable relative to a mouth jaw, for grasping ends of a spring band clamp, and the pliers legs are connected to each other in a crossover region.

Pliers of this type have already become known in various respects. Reference is made, for example, to DE 92 16 463 U1 and EP 0 677 357 A1 (U.S. Pat. No. 5,590,573 A). In the known pliers for the fitting of a spring band clamp, a wide opening of the pliers legs in the handle region is sometimes obtained, due to a large opening width of the pliers mouth. Also, in view of the desired large opening width of the pliers mouth, no favorable leverage ratios are achievable.

Starting from the aforementioned prior art, the invention concerns itself with the object of defining a pair of pliers for the fitting or removal of spring band clamps, which pliers are designed as favorably as possible from an ergonomic aspect with regard to manual forces which are to be applied.

According to a first inventive concept, a possible achievement of the object is given in a pair of pliers in which the main focal point is that the pliers legs are mutually adjustable in steps in order to change the size of the pliers mouth in the crossover region.

The step-by-step adjustability allows very favorable lever ratios. For adaptation to larger or smaller spring band clamps, the pliers mouth can be adjusted in the crossover region. The length of the pliers legs, or the jaw parts which form the pliers mouth, can be configured with comparatively small throat clearance in relation to the crossover region or single joint region of the pliers.

Pliers of this type have also already been disclosed per se, without said retaining elements, in a variety of respects. Reference is made, in particular, to EP 0 528 252 A1 (U.S. Pat. No. 5,845,551 A) and WO 2008/049850 A1 (US 20100064861 A). Such pliers are known, fundamentally, also as multigrip pliers. The use of such multigrip pliers for the fitting of spring band clamps, with the provision of retaining elements for grasping the ends of the spring band clamp in the pliers mouth, is a further aspect of the invention.

Further features of the invention are described or represented below also in the figure description of the drawing often in their preferred assignment to the concept which has already been described above, but they can also be of importance when assigned to just one or more individual features which are described or diagrammatized here, or independently, or in another overall concept.

It is thus preferred that a retaining element is configured with a central depression and, surrounding this, peripherally distributed, three or more peak regions. Of fundamental importance is that the retaining element is thus suitable for retentively receiving both one and the other end of a spring band clamp, which are differently shaped. While one end of a spring band clamp usually has a narrower, hook-shaped extension, the other end of the spring band clamp has a flat end region which usually occupies the entire width of the spring band. Since, further preferably, the retaining elements are of mutually identical configuration, preferably are identical parts, a simplification is obtained in this respect also, including in the handling of the pliers. The user does not have to pay attention to which end of the spring band clamp he assigns to which mouth jaw of the pliers mouth when taking receipt of the spring band clamp.

Moreover, it is preferred that a retaining element, in terms of its width, is tailored to the width of the mouth jaw. In particular, it is preferred that a retaining element protrudes not at all, or only slightly over the mouth jaw in the width direction.

In further detail, it is preferred that a retaining element has four peak regions. Furthermore, the peak regions, in particular said four peak regions, are also provided such that they are peripherally distributed at equal peripheral distance apart.

Not least, it is also preferred that a closed setting of the pliers mouth is lockable. This can be achieved, for example, by locking clips, which are known per se, in the region of the pliers legs.

The invention is explained in greater detail below with reference to the appended drawing, wherein:

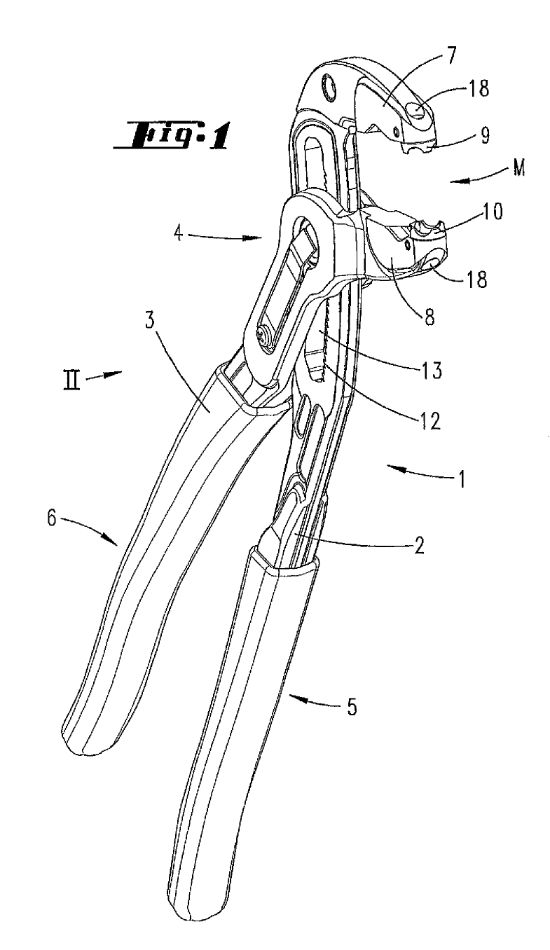

FIG. 1 shows a perspective view of the pliers;

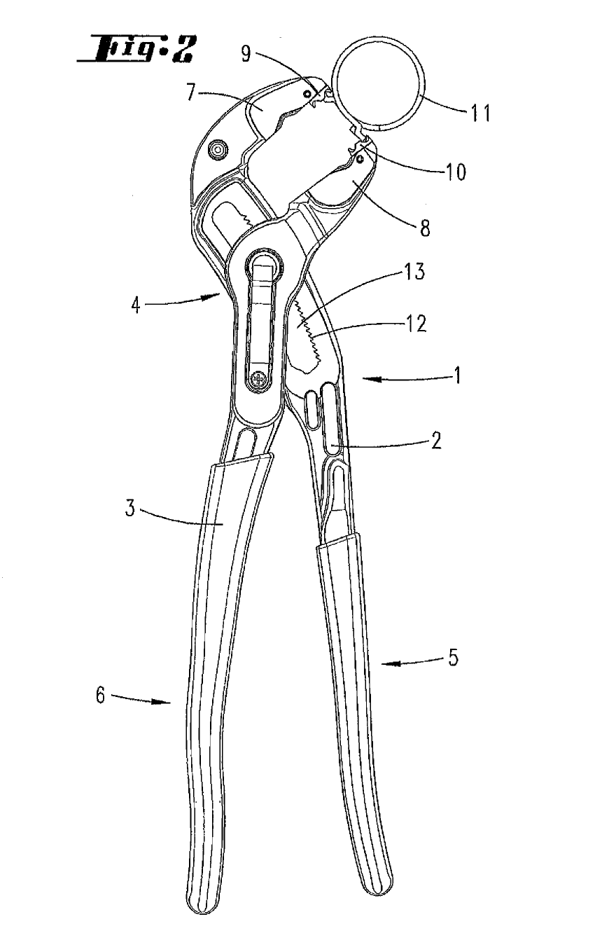

FIG. 2 shows a side view of the pliers with received spring band ring;

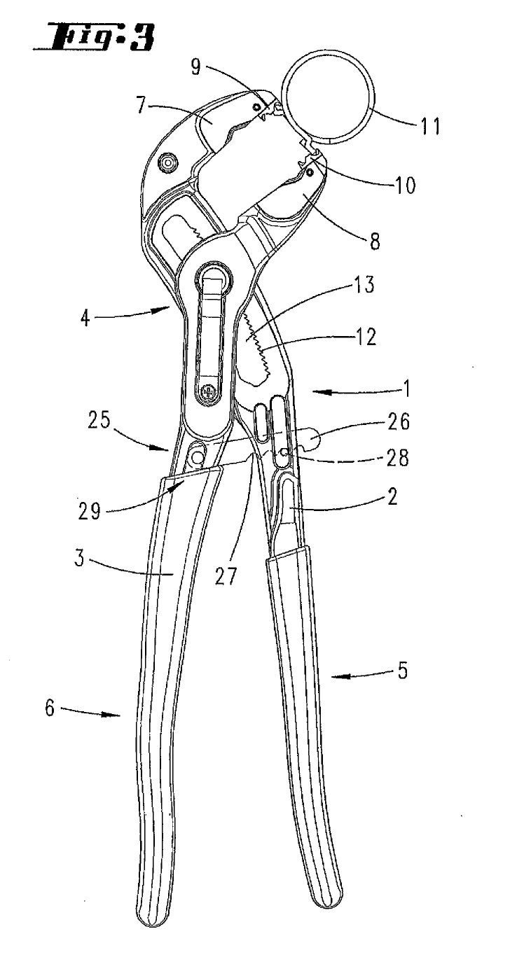

FIG. 3 shows a representation according to FIG. 2, with indicated locking device;

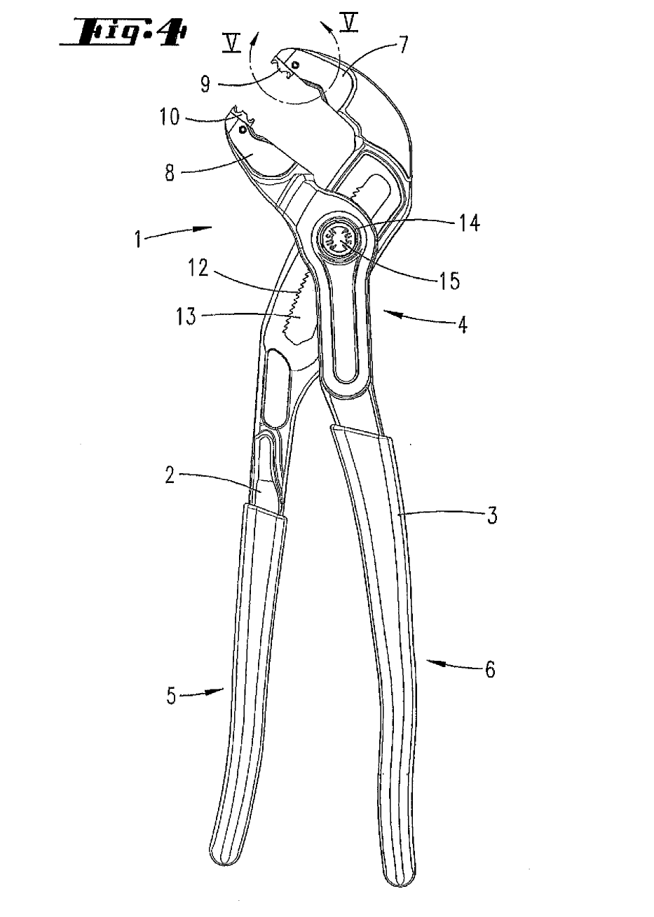

FIG. 4 shows a side view according to FIG. 2 or FIG. 3, from the opposite side, without spring band clamp;

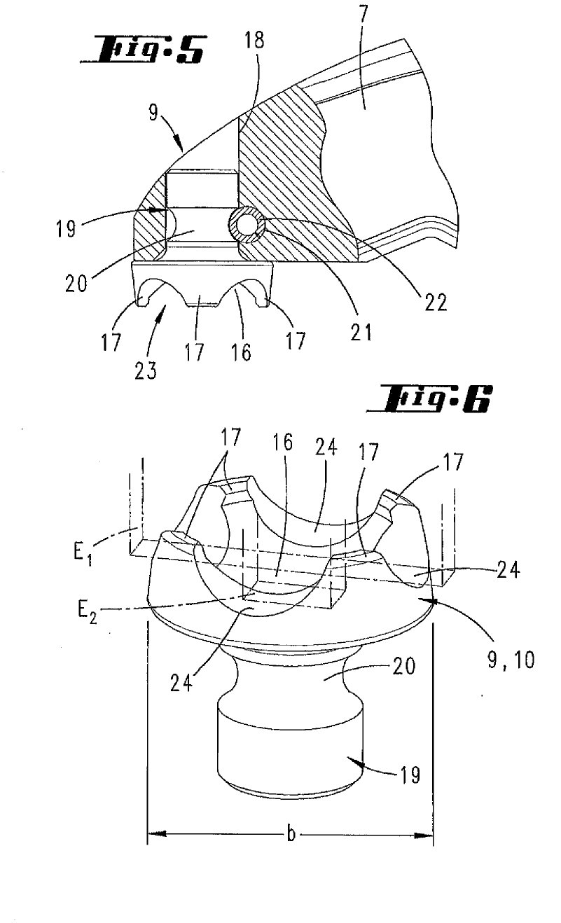

FIG. 5 shows a detailed view, in section, of a pliers mouth jaw with retaining part accommodated therein; and

FIG. 6 shows a detailed representation of a retaining element.

A pair of pliers 1, comprising two pliers legs 2, 3, which are articulately connected to each other in a crossover region 4, is represented and described firstly with reference to FIG. 1. On one side, the pliers legs 2, 3 form handle regions 5, 6, which, as in the illustrative embodiment, can be covered by grips. On the other side of the crossover region 4, the pliers legs 2, 3 form mouth jaws 7, 8, which form a pliers mouth M. The mouth jaws 7, 8 further have, assigned to their free ends, retaining elements 9, 10, for holding a spring band clamp 11, see FIGS. 2, 3.

In a further detail, one pliers leg 2 has an adjustment slot 13, which is provided, at least on one of its inner longitudinal sides, with a toothing 12 and extends in the longitudinal direction of the pliers leg 2. The other pliers leg 3 is configured in the crossover region 4 with a receptacle 14 for a joint pin 15. In the rest state, as is represented, for instance, in FIG. 2, the joint pin 15 is in interlocking engagement with the toothing 12. The mouth width, related to a distance of the joint pin 15 to the upper fixed mouth jaw 7, is fixed. Nevertheless, the mouth jaws 7 and 8 can still be pivoted relative to each other by pivoting of the pliers leg 3 relative to the pliers leg 2.

For the adjustment of the pliers mouth width, according to one embodiment it is necessary to depress the joint pin 15. In the depressed state, the interlocking engagement is removed and the pliers legs 2, 3 can be freely adjusted relative to each other. In another embodiment, it is in any event possible to achieve the adjustment of the pliers mouth width from a larger setting to a smaller setting without the need to depress the joint pin. A ratcheting overrun is obtained, as is explained in further detail, for example, in WO 2008/049850 A1 (US 20100064861 A1), cf., in particular, FIGS. 1 to 6 and associated description.

Each retaining element 9, 10 is accommodated in a freely rotatable manner in a pliers mouth jaw 7 or 8. In principle, however, because of the here provided crown-like configuration of a retaining element 9, 10, a fixed retaining element 9 and/or 10 can also be provided.

With reference to FIG. 5, the reception of a retaining element 9 in a pliers mouth jaw 7 is represented.

The pliers mouth jaw 7 has a bore 18, which runs transversely to its direction of opening and in which a neck portion 19 of the retaining element 9 is accommodated. The neck portion 19 has in further detail a circumferential groove 20 which is rounded on the bottom. In the illustrative embodiment, in a transverse bore 21 to the bore 18, for the rotatable mounting of the retaining element 9, is accommodated a cotter pin 22, which prevents removal of the retaining element 9, yet nevertheless allows rotation of the retaining element 9.

The crown region 23, which is larger in diameter than the neck portion 19, sits on the outside of the assigned face of the mouth jaw 7.

A retaining element 9, 10 is represented in further detail in FIG. 6.

Of fundamental importance is that a central depression 16 of the retaining element 9, 10, in the illustrative embodiment, is surrounded by four peak regions 17. As is indicated in dash-dot representation, both ends E₁ which are wider than equivalent to the width b of the retaining element and ends E₂ of a spring band clamp which are narrower than equivalent to the width b can in this way be securely received in said retaining element. They then intrude into the depression 16 and are thus secured in the depression 16.

Between the peak regions 17, indentations 24, which in profile are rounded on the bottom and which preferably in said profile run in the shape of a circular segment, are configured. The ends E₁ sit evidently only on the indentations 24, while the ends E₂ can sit centrally and such that they reach deeper into the depression 16.

With reference to FIG. 3, a locking device 25 is indicated. Any suitable locking device can here be used. Merely by way of example, the locking device is represented in the possible form of a locking bolt 26 having, on one side, a plurality of latching recesses 27 which can cooperate with a latching pin 28. While the locking bolt 26 can be fastened rotatably, as indicated by a pivot joint 29, to one pliers leg 3, the latching pin 28 is fastened to the other pliers leg 2. The different latching recesses can be used to fix different pivot opening settings of the pliers mouth jaws 7, 8 relative to one another, given a chosen fixed pliers mouth opening width.

A specific state of tension of a gripped spring band clamp can thus be maintained.

All disclosed features are (in their own right) fundamental to the invention. The disclosure of the Application also herewith fully incorporates the disclosure content of the associated/appended priority documents (copy of the prior application), including for the purpose of jointly adopting features of these documents within claims belonging to the present Application. The subclaims characterize, in their optionally coordinated version, an independent inventive refinement of the prior art, in particular in order to make divisional applications on the basis of these claims.

### REFERENCE SYMBOL LIST

1 pliers
2 pliers leg
3 pliers leg
4 crossover region
5 handle region
6 handle region
7 mouth jaw
8 mouth jaw
9 retaining element,
10 retaining element
11 spring band clamp
12 toothing
13 adjustment slot
14 receptacle
15 joint pin
16 depression
17 peak regions
18 bore
19 neck portion
20 groove
21 transverse bore
22 cotter pin
23 crown region
24 indentation
25 locking device
26 locking bolt
27 latching recess
28 latching pin
29 pivot joint
E₁ end
E₂ end
M pliers mouth
b width

1. A pliers (1), comprising two pliers legs (2, 3) and a pliers mouth (M) formed by mouth jaws (7, 8), wherein in the pliers mouth (M) are arranged holding elements (9), which are rotatable relative to a mouth jaw (7, 8), for grasping ends of a spring band clamp (11), and the pliers legs (2, 3) are connected to each other in a crossover region (4), wherein the pliers legs (2, 3) are mutually adjustable in steps in order to change the size of the pliers mouth (M) in the crossover region (4).

2. The pliers as claimed in claim 1, wherein a retaining element (9, 10) is configured with a central depression (16) and, surrounding this, peripherally distributed, three or more peak regions (17).

3. The pliers as claimed in claim 1, wherein the retaining elements (9, 10) are of mutually identical configuration.

4. The pliers as claimed in claim 1, wherein four peak regions (17) are formed.

5. The pliers as claimed in claim 1, wherein a closed setting of the pliers mouth (M) is lockable.
